(19) United States
(12) Patent Application Publication
(10) Pub. No.: US 2012/0305805 A1
(43) Pub. Date: Dec. 6, 2012

(54) LASER APPARATUS

(75) Inventors: Shinobu TAMAOKI, Yokohama-shi (JP); Motoki KAKUI, Yokohama-shi (JP)

(73) Assignee: SUMITOMO ELECTRIC INDUSTRIES, LTD., Osaka-shi (JP)

(21) Appl. No.: 13/485,477

(22) Filed: May 31, 2012

Related U.S. Application Data
(60) Provisional application No. 61/493,221, filed on Jun. 3, 2011.

(30) Foreign Application Priority Data
Jun. 3, 2011 (JP) P2011-125232

(51) Int. Cl. B01J 19/12

(52) U.S. Cl. 250/492.1

(57) ABSTRACT

The present invention relates to a laser apparatus having a structure for facilitating the change of a transparent wavelength band of a bandpass filter in accordance with a central wavelength of pulsed light. In the laser apparatus, the transparent wavelength band of light to be transmitted through a BPF is changed according to the central wavelength of the pulsed light when the pulse width of the pulsed light outputted from a seed light source is changed.

### CROSS-REFERENCE TO RELATED APPLICATION

This application is based upon and claims the benefit of priorities from U.S. Provisional Application No. 61/493,221, filed on Jun. 3, 2011 and Japanese Patent Application No. 2011-125232, filed on Jun. 3, 2011, the entire contents of which are incorporated herein by reference.

### BACKGROUND OF THE INVENTION

1. Field of the Invention

The present invention relates to a laser apparatus.

2. Related Background Art

Today, processing technology using lasers is attracting attention, and demands for high-power lasers are increasing in various fields including the processing field and medical field. In particular, fiber lasers containing an optical fiber doped with rare earth elements such as Yb and which adopts an amplification using pumping light or resonator structure is attracting attention since it is easy to handle and does not require a large-scale cooling facility since the thermal radiation is favorable. As one such fiber laser, known is MOPA (Master Oscillator Power Amplifier) which achieves high power by pulsing the light output from a light source by direct modulation or external modulation, and additionally amplifying the obtained pulsed light.

### SUMMARY OF THE INVENTION

The present inventors have examined the above prior art, and as a result, have discovered the following problems. That is, in the case of changing the pulse width of the pulsed light output from a laser apparatus which uses FP (Fabry-Perot)-type LD, there is a case where the central wavelength of the pulsed light changes. In this case, when a bandpass filter which only allows the transmission of light in a specific wavelength band is used in the amplifier or the like for amplifying the pulsed light in the laser apparatus, it was assumed that the transparent wavelength band of the bandpass filter needed to be changed in accordance with the change of the central wavelength of the pulsed light. When the transparent wavelength band of the bandpass filter is of a fixed type, it is necessary to replace the bandpass filter itself, and changing the transparent wavelength band is not necessarily easily.

The present invention has been developed to eliminate the problems described above. It is an object of the present invention to provide a laser apparatus having a structure for facilitating the change of the transparent wavelength band of a bandpass filter in accordance with a central wavelength of pulsed light.

In order to achieve the above-mentioned object, a laser apparatus according to the present invention comprises, as a first aspect, a light source, a bandpass filter, and a setting unit. The light source outputs pulsed light of which central wavelength can be adjusted. The bandpass filter can be controlled to selectively transmit a light component of a predetermined transparent wavelength band, in the pulsed light inputted from the light source thereto. The setting unit sets the transparent wavelength band of the bandpass filter according to the central wavelength of the pulsed light outputted from the light source.

In accordance with the laser apparatus according to the first aspect, since the wavelength band of light to be transmitted through the bandpass filter is set by the setting unit according to the central wavelength of the pulsed light outputted from the light source, the transparent wavelength band can be changed without replacing the bandpass filter.

Here, as a second aspect applicable to the first aspect, the setting unit may change a pulse width of the pulsed light by changing the central wavelength of the pulsed light outputted from the light source. Moreover, as a third aspect applicable to at least one of the first and second aspects, the setting unit may include a control unit for automatically changing the transparent wavelength band according to the central wavelength of the pulsed light. As a fourth aspect applicable to any one of the first to third aspects, the setting unit may perform control to change the central wavelength of the pulsed light and the transparent wavelength band according to a set pattern selected from a plurality of types of set patterns in which a relationship between the central wavelength of the pulsed light and the transparent wavelength band corresponding thereto is set in advance. In addition, as a fifth aspect applicable to at least one of the first to fourth aspects, the central wavelength of the pulsed light may be set in accordance with the pulse width of the pulsed light outputted from the light source.

As a sixth aspect applicable to the third aspect, the control unit may change the transparent wavelength band of the bandpass filter based on a change in a voltage to be inputted to the bandpass filter. As a seventh aspect applicable to the third or sixth aspect, a plurality of different transparent wavelength bands may be set for the bandpass filter, and the control unit may select and set one transparent wavelength band among the plurality of transparent wavelength bands according to the central wavelength of the pulsed light. As an eighth aspect applicable to at least one of the third, sixth and seventh aspects, the control unit may additionally change a width of the transparent wavelength band of the bandpass filter according to the central wavelength of the pulsed light outputted from the light source.

In accordance with the first to eighth aspects, it is possible to cut excess light other than the light to be transmitted through the bandpass filter, such as ASE light, by narrowing the wavelength bandwidth, and thereby obtain a stable amplification effect.

Moreover, as a ninth aspect applicable to at least one of the first to eighth aspects, the laser apparatus may further include an amplifier for amplifying the pulsed light. In the ninth aspect, preferably, the bandpass filter is disposed in a stage that is subsequent to the amplifier and selectively transmits a light component in a predetermined transparent wavelength band in the light amplified by the amplifier.

In addition, as a tenth aspect applicable to at least one of the first to ninth aspects, a plurality of filters having different transparent wavelength bands may be provided side by side in the bandpass filter. As a result of providing a plurality of filters having different transparent wavelength bands side by side, it is possible to facilitate the switching of filters and achieve a more simple configuration.

### BRIEF DESCRIPTION OF THE DRAWINGS

FIG. 1 is a view showing the schematic configuration of a conventional laser apparatus;

FIG. 2 is a view showing the relationship between the pulse width and the central wavelength of the pulsed light;

FIG. 3 is a view showing the relationship between the temperature of the seed light source and the central wavelength of the pulsed light;

FIG. 4 is a view showing an example of the transparent wavelength of the bandpass filter;

FIG. 5 is a view showing the schematic configuration of an embodiment of the laser apparatus according to the present invention;

FIG. 6 is a view for explaining an example of the control method of the bandpass filter;

FIG. 7 is a view for explaining another example of the control method of the bandpass filter;

FIGS. 8A and 8B shows views for explaining the configuration of the transmission filter that is used in the bandpass filter; and

FIG. 9 is a view for explaining a case of narrowing the half-value width of the bandpass filter.

### DESCRIPTION OF THE PREFERRED EMBODIMENTS

In the following, embodiments for carrying out the present invention will be explained in detail with reference to the appended drawings. Note that the same reference numeral is given to the same element in the explanation of the drawings, and the redundant explanation thereof is omitted. In the ensuing explanation, a conventional laser apparatus is foremost explained, and the configuration of the laser apparatus according to this embodiment is subsequently explained.

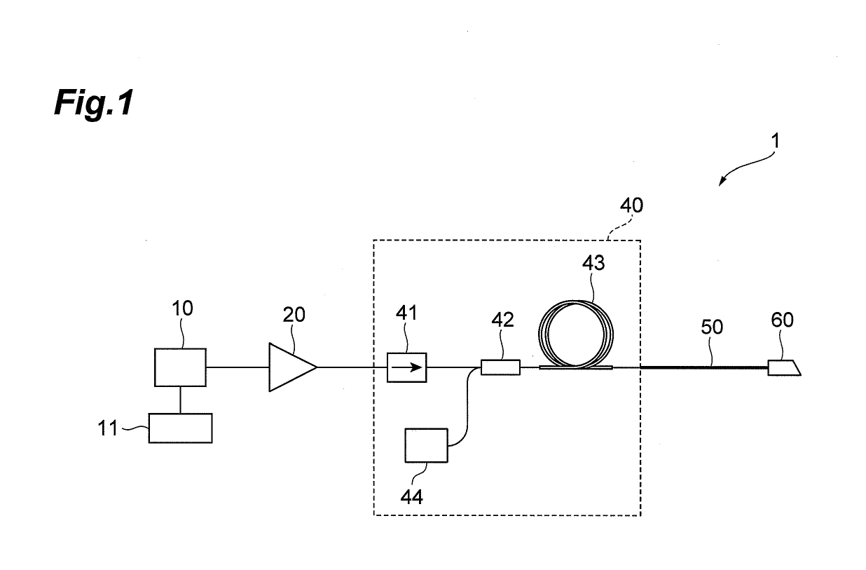

FIG. 1 is a view showing the schematic configuration of a conventional laser apparatus. The laser apparatus 1 shown in FIG. 1 is a MOPA (Master Oscillator Power Amplifier)-type fiber laser, and comprises a seed light source 10, a pulse generator 11, an intermediate amplifier 20 and a final amplifier 40. The seed light source 10 preferably includes a laser diode. The pulse generator 11 modulates the seed light source 10 by direct modulation or external modulation. Consequently, light from the seed light source 10 becomes pulsed light. In other words, the seed light source 10 and the pulse generator 11 function as a pulsed light source which outputs light during a predetermined output period. The intermediate amplifier 20 amplifies the light outputted from the seed light source 10. The final amplifier 40 additionally amplifies the light that was amplified by the intermediate amplifier 20. In other words, with the laser apparatus 1, the pulsed light modulated by the pulse generator 11 and outputted from the seed light source 10 is sequentially amplified by the intermediate amplifier 20 and the final amplifier 40. Subsequently, the pulsed light outputted from the final amplifier 40 passes through a propagation fiber 50 disposed in a stage that is subsequent to the final amplifier 40, and is thereafter outputted to the outside of the laser apparatus 1 through an exit end 60.

The pulse generator 11 is a device for modulating the seed light source 10, and includes a function for manually controlling the start/end of the pulse operation, and a function for controlling the start/end of the pulse operation by using an external control signal or the like. Generally speaking, the device that sends control signals to the pulse generator 11 is often a device that is different from the laser apparatus 1 such as a processing unit or a PC.

The final amplifier 40 comprises an optical isolator 41, an optical combiner 42, an amplification optical fiber 43, and a pumping light source 44.

The optical isolator 41 allows the light outputted from the intermediate amplifier 20 to pass through the optical combiner 42, but does not allow the light to pass through in the opposite direction. The optical combiner 42 inputs the light to be amplified which arrived from the optical isolator 41, inputs the pumping light which arrived from the pumping light source 45, combines the light to be amplified and pumping light, and outputs the combined light to the amplification optical fiber 43.

The amplification optical fiber 43 amplifies the light to be amplified by wave-guiding the light to be amplified and the pumping light which arrived from the optical combiner 42. The foregoing amplified light is outputted to the delivery optical fiber 50 disposed in a stage that is subsequent to the final amplifier 40. The delivery optical fiber 50 wave-guides the light which arrived from the amplification optical fiber 43 from one end to the other end, and outputs such light to the outside of the laser apparatus 1 from the exit end 60 connected to the other end.

The amplification optical fiber 43 is an optical fiber having a double cladding structure, and is doped with rare earth elements (for instance, Yb, Er, Nd, Tm, Ho, Tb and the like). The amplification optical fiber 43 comprises a core region through which light to be amplified propagates, an inner cladding region which surrounds the core region and through which at least pumping light propagates, and an outer cladding region which surrounds the inner cladding region. Moreover, absorption of the pumping light in the amplification optical fiber 43 is decided by the characteristics of the amplification fiber 43, and the absorption mainly changes by adjusting the MFD of the core, the diameter of the inner cladding region, and the additive concentration of rare earths of the core region. For example, with a Yb-doped fiber having an additive concentration of approximately 10000 ppm, MFD of approximately 7 μm, an inner cladding region diameter of approximately 130 μm, and a length of 5 m, pumping light of approximately 2.4 dB is absorbed in a pumping wavelength of a 915 nm band (915±20 nm). Note that with this fiber absorption example, the pumping wavelength of a 915 nm band was used for amplifying the Yb-doped fiber, but a 940 nm band (940±5 nm) or a 976 nm band (976±5 nm) may also be used.

Moreover, the delivery optical fiber 50 is an optical fiber of a single cladding structure having a core diameter and NA that are equivalent to the amplification optical fiber 43.

Note that, while the light of the seed light source 10 can be outputted as pulsed light using either method of direct modulation or external modulation, direct modulation is adopted in the laser apparatus 1. When pulsed light is outputted due to direct modulation, the output/suspension of light from the seed light source 10 is switched by changing the amount of current that is supplied to the seed light source 10, and provided are a current circuit for causing current to constantly flow, and a modulation drive unit for receiving a pattern of a modulator from the outside and supplying such pattern to the seed light source 10.

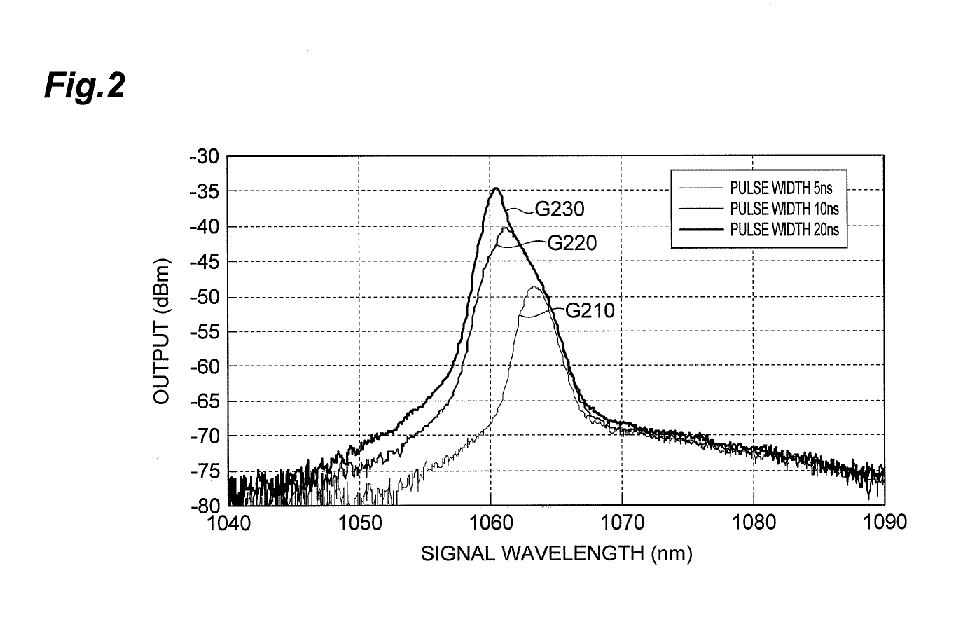

Here, the central wavelength characteristics according to the pulse width of the pulsed light outputted from the seed light source 10 are shown in FIG. 2. FIG. 2 shows the output intensity of pulsed light when the pulse width of the pulsed light is set to 5 ns, 10 ns, and 20 ns. Specifically, a graph G210 shows the output intensity of the pulsed light having a pulse width of 5 ns, a graph G220 shows the output intensity of the pulsed light having a pulse width of 10 ns, and a graph G230 shows the output intensity of the pulsed light having a pulse width of 20 ns, respectively. As evident from FIG. 2, when the pulse width changes, the central wavelength also changes. Note that Japanese Patent Application Laid-Open No 2009-152560 (Patent Document 1) discloses a light source in which the pulse width of the pulsed light also changes pursuant to the change in the central wavelength of the output pulsed light, and it is also possible to adjust the pulse width of the pulsed light by changing the central wavelength of the pulsed light. However, with the conventional laser apparatus 1, when a bandpass filter is included in the configuration of the intermediate amplifier 20, the transparent wavelength band of the bandpass filter needs to be changed if the central wavelength of the pulsed light changes. Thus, normally, adjustment for inhibiting the change of the central wavelength of the pulsed light is performed.

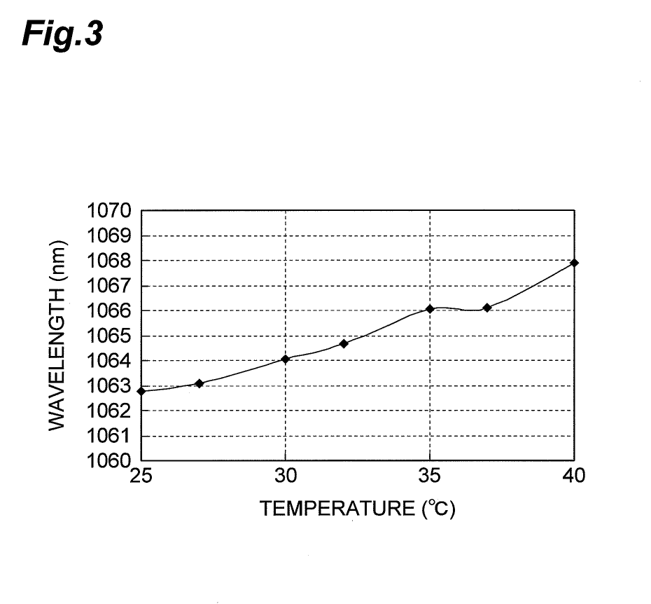

When a semiconductor laser diode (LD) is used as the seed light source 10 of the laser apparatus 1, it is known that the central wavelength will change if, as the characteristics of the LD, the set temperature is changed or the amount of current supplied to the LD is changed. Among the above, if the central wavelength is changed by changing the amount of current, there are cases where the design of the intermediate amplifier 20 or the like needs to be changed in accordance with the change in the amount of current. Accordingly, it is difficult to change the central wavelength of the pulsed light by changing the amount of current. Thus, adjustment of the central wavelength associated with the change in the pulse width of the pulsed light is often performed by adjusting the temperature of the light to be amplified. Here, the change characteristics of the central wavelength of the pulsed light from the seed light source 10 upon changing the temperature are shown in FIG. 3.

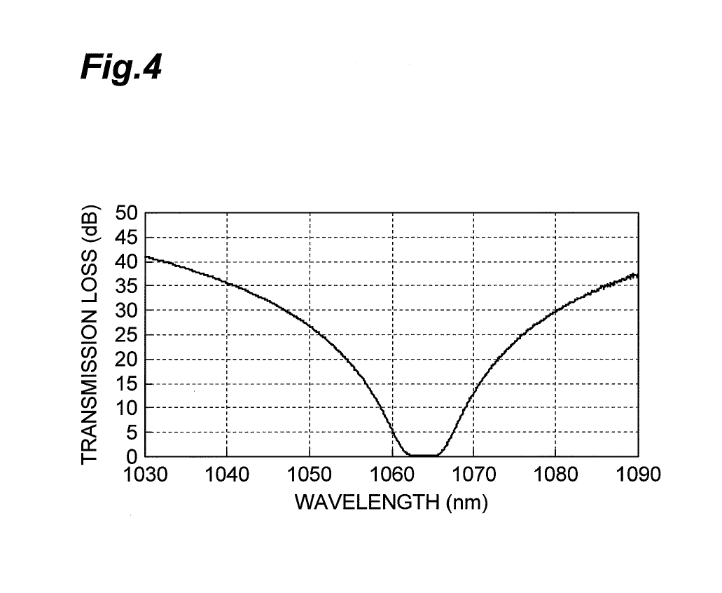

Next, the transparent wavelength of a bandpass filter (BPF), which is often used in the intermediate amplifier 20, is shown in FIG. 4. A BPF is characterized in that it only transmits light in a specific wavelength range (transparent wavelength band) with low loss, and blocks light other than the specific wavelength range with high loss. In other words, a BPF includes a function of selectively transmitting light in a predetermined transparent wavelength band. In addition to the type of BPF including a function of manually varying the low-loss transparent wavelength band as shown in FIG. 4, there is also a type of BPF in which the transparent wavelength band is fixed.

Here, when the transparent wavelength band of the BPF is fixed and the central wavelength of the pulsed light from the seed light source 10 changes, adopted is a method of changing the central wavelength by replacing the BPF itself to a type which corresponds to the central wavelength, or adjusting the temperature of the pulsed light from the seed light source 10. Nevertheless, upon changing the temperature with the seed light source 10, there are cases where waiting time is required until the temperature is stabilized, a high-temperature region for shortening the life of the seed light source 10 itself needs to be set, or a temperature in which the seed light source 10 does not operate stably needs to be set.

Moreover, when the transparent wavelength band of the BPF can be manually changed, preferably adopted is the method of manually adjusting the transparent wavelength band of the BPF in accordance with the change of the central wavelength associated with the change of the pulse width of the pulsed light. Nevertheless, there is a possibility that the optical components configuring the laser apparatus 1 may become damaged due to the prolonged adjustment time or adjustment errors associated with the manual adjustment of the BPF.

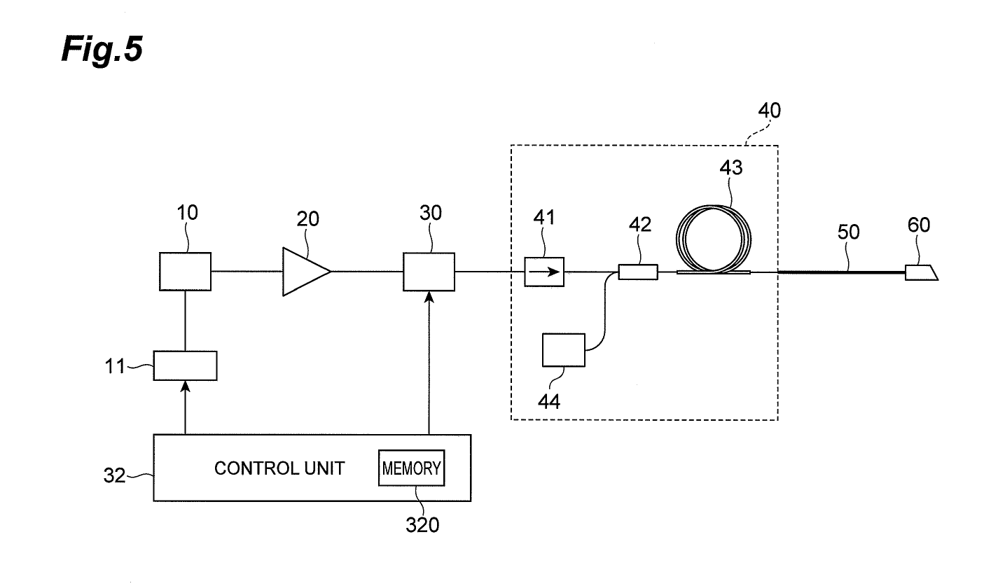

Therefore, the configuration of a laser apparatus 2 according to this embodiment capable of resolving the foregoing problem is shown in FIG. 5. In the laser apparatus 2 of FIG. 5, a BPF 30 is provided in a stage that is subsequent to the intermediate amplifier 20. In addition, provided is a control unit 32 (included in the setting unit) to be connected to the pulse generator 11 and the BPF 30. This control unit 32 functions as a setting unit for setting a transparent wavelength band according to the central wavelength of the pulsed light outputted from the pulsed light source. Moreover, the control unit 32 includes a memory 320 for storing electronic data such as set patterns and the like which are prepared in advance. The BPF 30 includes a function of changing the transparent wavelength band of the BPF 30 based on a signal from the control unit 32. In addition, the control unit 32 issues a command for changing the transparent wavelength band of the light to be transmitted through the BPF 30 according to the pulse width of the pulsed light that is controlled by the pulse generator 11. Note that an intermediate amplifier 20 is provided to the laser apparatus 2, but in cases where there is no intermediate amplifier 20, the BPF 30 should be provided between the seed light source 10 and the final amplifier 40. Accordingly, the intermediate amplifier 20 is not an essential constituent element.

In the BPF 30, as the method of changing the transparent wavelength band, there is the method of using a transmission filter or the like with characteristics in which the transparent wavelength band changes according to the input position of the light and changing the position of the light to be inputted to the transmission filter, or the method of changing the relative positional relationship of the transmission filter and the input position of the light by changing the position of the transmission filter itself as a result of rotating the transmission filter. According to the foregoing mechanism, the transparent wavelength band can be changed inside the BPF 30 based on a signal from the control unit 32 provided outside the BPF 30.

As the method of sending a signal from the outside control unit 32 to the BPF 30, there is the method of outputting, to the BPF 30, a control voltage signal from the control unit 32 as the control substrate which issues a command for changing the pulse width of the pulsed light outputted from the seed light source 10. Note that the relationship of the pulse width of the pulsed light from the seed light source 10 and the central wavelength of the pulsed light of the pulse width is preferably comprehended in advance (see Patent Document 1).

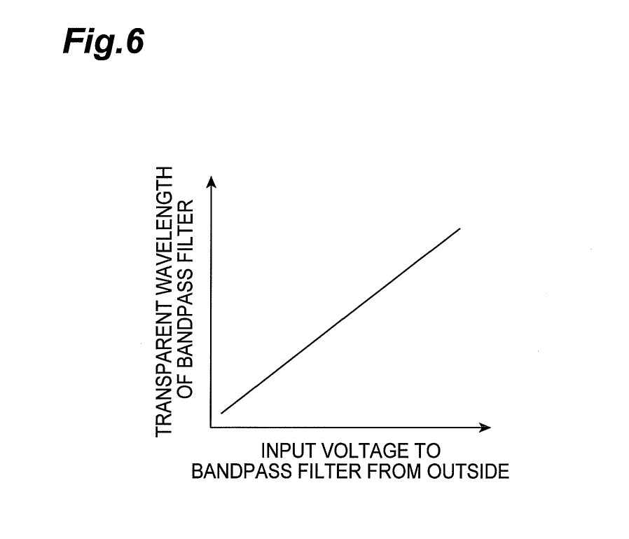

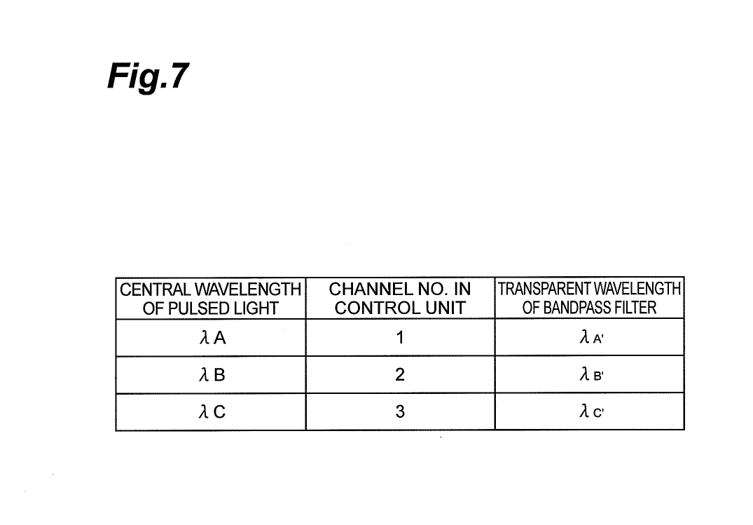

With respect to how to control the wavelength band of the light to be transmitted through the BPF 30, for instance, as shown in FIG. 6, considered may be the method of uniformly changing the transparent wavelength band relative to the control voltage to be inputted to the BPF 30. Moreover, as a method that is different from the foregoing method, as shown in FIG. 7, considered may be the method of providing, in the control unit 32, a plurality of channels (set patterns) which associate the central wavelength of the pulsed light and the transparent wavelength in the BPF 30 in advance, and changing both the pulse width of the pulsed light and the transparent wavelength band of the BPF 30 by changing the channels. In the foregoing case, the plurality of types of channels (set patterns) set in advance are stored in the memory 320 of the control unit 32.

Specifically, FIG. 6 shows the characteristics where the central wavelength of the bandpass filter is dependent on the voltage applied to the bandpass filter and changes to linearity. Relative to FIG. 6, FIG. 7 shows that the central wavelength of the bandpass filter is given a fixed value for each level as a position set value and changes gradually, rather than changing continuously relative to the voltage. If the central wavelength of the bandpass filter is given a fixed value, there is no possibility of the central wavelength of the bandpass filter fluctuating due to a pulse of an outside voltage. For example, 1060 nm when set to position 1, 1061 nm when set to position 2, 1064 nm when set to position 3, and so on may be decided. If a pulse width of 5 ns is selected when the pulse width of the light to be amplified changes, the central wavelength of the light to be amplified will be 1060 nm. In the foregoing case, position 1 is set.

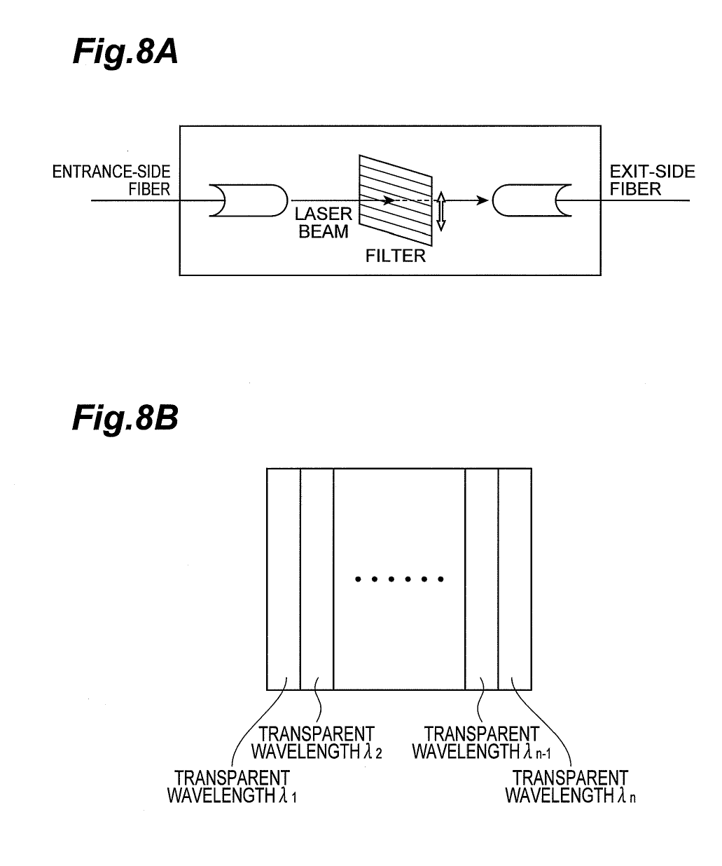

Moreover, the structure of the transmission filter when the transparent wavelength band of the BPF 30 is changed is also explained. Normally, as the medium to be used as the transmission filter, a dielectric multilayer filter is often used, and the transparent wavelength is decided according to the material of the film to be produced. The filter used in the BPF 30 of this embodiment in which the transparent wavelength band is variable is formed by a plurality of filters having different transparent wavelength bands, and is characterized in that the transparent wavelength band is decided differently based on the where the light is irradiated. Specifically, FIG. 8B shows an internal structural example of the bandpass filter. As a result of forming a stripe-shaped film in which regions where the transparent wavelengths (λ1 to λn) are different are aligned, a variable bandpass filter can be produced with a simple configuration. The stripe shape may be arranged vertically or arranged horizontally. In the foregoing case, as shown in FIG. 8A, adjustment is enabled by installing a filter and vertically moving the film position to select the appropriate film position and obtain the intended central wavelength.

In the bandpass filter disposed inside the optical amplifier, the I/O port is an optical fiber. Inside the bandpass filter, a collimator lens is disposed at the tip of the I/O end from the optical fiber. The collimated light obtained by the collimator lens collimating the input light is inputted to the filter to decide the transparent wavelength. The light that was transmitted through the filter once again passes through the collimator lens and is focused at the exit end, and integrated to the exit-side optical fiber. FIG. 8B shows a state where a filter film having different transparent wavelengths is deposited in a stripe shape, and the transmission characteristics of the bandpass filer are decided depending on which portion is irradiated with the input light. FIG. 8A shows a state where the filter film of FIG. 8B is arranged in the horizontal direction, and, by vertically moving the filter itself in the vertical direction, the laser beam can be irradiated to the portion having transparent wavelength characteristics. As the means for moving the filter film in the vertical direction, the incident position of the input light to the filter can be changed by using an outside voltage and moving the filter film in the vertical direction, and the central transparent wavelength of the bandpass filter can be varied by using an outside voltage as the characteristics of the overall bandpass filter.

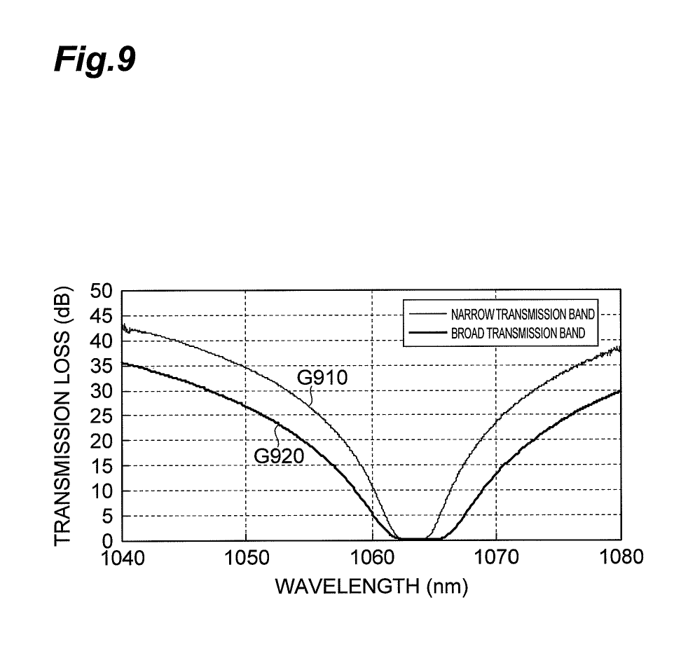

Moreover, upon producing a film having a plurality of different transparent wavelength ranges used in the foregoing filter, the film may also be formed so that the half-value width of the transparent wavelength band (defined as a wavelength band in which the increment of loss is 3 dB or less when compared to the minimal loss in the filter). Since the spectrum width of the pulsed light may change depending on the wavelength of the pulsed light, preferably, the transmission characteristics of the BPF 30 according to the spectrum width of the pulsed light are attained. If it is possible to optimize the spectrum width of the light to be transmitted in the BPF 30, it is possible to cut excess light other than light to be transmitted such as ASE light, and obtain a stable amplification effect. FIG. 9 shows the transmission spectrum of the BPF with a narrowed half-value width. A film in which the half-value width is changed as described above can also be used in the BFP 30. Note that, in FIG. 9, the graph G910 shows the transmission spectrum of the BPF having a narrow transmission band, and the graph G920 shows the transmission spectrum of the BPF having a broad transmission band.

As described above, in accordance with to the laser apparatus 2 of this embodiment, when the pulse width is changed, in comparison to the method of changing the wavelength of the pulsed light itself by changing the temperature of the light source as in conventional technologies, the waiting time until the temperature stabilizes is no longer required, and there is no longer any need to replace the BPF 30 or manually adjust the transparent wavelength band of the BPF 30. Accordingly, the laser apparatus 2 is able to shorten the adjustment time and prevent the damage of optical components including lasers caused by adjustment errors.

Note that the configuration may also be such that the BPF 30 is provided in a stage that is subsequent to the final amplifier 40. In the foregoing case also, the BPF 30 can selectively transmit light in a predetermined wavelength band and, in accordance with the central wavelength of the pulsed light outputted from the seed light source 10, the transmission wavelength band thereof can be easily changed.

In accordance with the present invention, the change of the transparent wavelength band of a bandpass filter in accordance with a central wavelength of pulsed light is facilitated. Moreover, in comparison to the method of changing the wavelength of the pulsed light itself by changing the temperature of the light source as in conventional technologies, the waiting time until the temperature stabilizes is no longer required, and there is no longer any need to replace the BPF or manually adjust the transparent wavelength band of the BPF. Accordingly, it is possible to shorten the adjustment time and prevent the damage of optical components including lasers caused by adjustment errors.

What is claimed is:

1. A laser apparatus, comprising:
a light source which outputs pulsed light of which central wavelength can be adjusted;
a bandpass filter which can be controlled to selectively transmit a light component of a predetermined transparent wavelength band, in the pulsed light inputted from the light source thereto; and
a setting unit which sets the transparent wavelength band of the bandpass filter according to the central wavelength of the pulsed light outputted from the light source.

2. The laser apparatus according to claim 1, wherein the setting unit changes a pulse width of the pulsed light by changing the central wavelength of the pulsed light outputted from the light source.

3. The laser apparatus according to claim 1, wherein the setting unit includes a control unit which automatically changes the transparent wavelength band according to the central wavelength of the pulsed light.

4. The laser apparatus according to claim 1, wherein the setting unit performs control to change the central wavelength of the pulsed light and the transparent wavelength band according to a set pattern selected from a plurality of types of set patterns in which a relationship between the central wavelength of the pulsed light and the transparent wavelength band corresponding thereto is set in advance.

5. The laser apparatus according to claim 4, wherein the central wavelength of the pulsed light is set according to the pulse width of the pulsed light outputted from the light source.

6. The laser apparatus according to claim 3, wherein the control unit changes the transparent wavelength band of the bandpass filter based on a change in a voltage to be inputted to the bandpass filter.

7. The laser apparatus according to claim 3, wherein a plurality of different transparent wavelength bands can be set for the bandpass filter, and
wherein the control unit selects and sets one of the plurality of transparent wavelength bands according to the central wavelength of the pulsed light.

8. The laser apparatus according to claim 3, wherein the control unit additionally changes a width of the transparent wavelength band of the bandpass filter according to the central wavelength of the pulsed light outputted from the light source.

9. The laser apparatus according to claim 1, further comprising an amplifier which amplifies the pulsed light,
wherein the bandpass filter is disposed in a stage that is subsequent to the amplifier and selectively transmits a light component in the predetermined transparent wavelength band in the light amplified by the amplifier.

10. The laser apparatus according to claim 1, wherein a plurality of filters having different transparent wavelength bands are provided side by side in the bandpass filter.
